(19) United States
(12) Patent Application Publication
(10) Pub. No.: US 2004/0111718 A1
(43) Pub. Date: Jun. 10, 2004

(54) Block-offset table employing gaps in value set

(76) Inventor: David L. Detlefs, Westford, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/309,910

(22) Filed: Dec. 4, 2002

(51) Int. Cl. G06F 9/45; G06F 9/44

(52) U.S. Cl. 717/151; 717/164

(57) ABSTRACT

A garbage collector maintains a block-offset table. That table contains locator information including an entry for each of a plurality of “cards” into which the collector treats at least a portion of heap memory as divided. Certain of the code values that an entry can assume specify the location of the object or free block in which the card begins. Other codes indicate that such information can be obtained from a table entry some number of table entries ahead of the entry that assumes that value. The possible offset values in the encoding populate only very sparsely the range between the highest and lowest values represented by the possible code values. By thus leaving large gaps in the range of possible offsets encoded, a collector can achieve an advantageous compromise between the expense of finding a block location and the expense of updating the block-offset table.

### BACKGROUND OF THE INVENTION

1. Field of the Invention

The present invention is directed to memory management. It particularly concerns what has come to be known as “garbage collection.”

2. Background Information

In the field of computer systems, considerable effort has been expended on the task of allocating memory to data objects. For the purposes of this discussion, the term object refers to a data structure represented in a computer system's memory. Other terms sometimes used for the same concept are record and structure. An object may be identified by a reference, a relatively small amount of information that can be used to access the object. A reference can be represented as a “pointer” or a “machine address,” which may require, for instance, only sixteen, thirty-two, or sixty-four bits of information, although there are other ways to represent a reference.

In some systems, which are usually known as “object oriented,” objects may have associated methods, which are routines that can be invoked by reference to the object. They also may belong to a class, which is an organizational entity that may contain method code or other information shared by all objects belonging to that class. In the discussion that follows, though, the term object will not be limited to such structures; it will additionally include structures with which methods and classes are not associated.

The invention to be described below is applicable to systems that allocate memory to objects dynamically. Not all systems employ dynamic allocation. In some computer languages, source programs must be so written that all objects to which the program's variables refer are bound to storage locations at compile time. This storage-allocation approach, sometimes referred to as “static allocation,” is the policy traditionally used by the Fortran programming language, for example.

Even for compilers that are thought of as allocating objects only statically, of course, there is often a certain level of abstraction to this binding of objects to storage locations. Consider the typical computer system 10 depicted in FIG. 1, for example. Data, and instructions for operating on them, that a microprocessor 11 uses may reside in on-board cache memory or be received from further cache memory 12, possibly through the mediation of a cache controller 13. That controller 13 can in turn receive such data from system read/write memory (“RAM”) 14 through a RAM controller 15 or from various peripheral devices through a system bus 16. The memory space made available to an application program may be “virtual” in the sense that it may actually be considerably larger than RAM 14 provides. So the RAM contents will be swapped to and from a system disk 17.

Additionally, the actual physical operations performed to access some of the most-recently visited parts of the process's address space often will actually be performed in the cache 12 or in a cache on board microprocessor 11 rather than on the RAM 14, with which those caches swap data and instructions just as RAM 14 and system disk 17 do with each other.

A further level of abstraction results from the fact that an application will often be run as one of many processes operating concurrently with the support of an underlying operating system. As part of that system's memory management, the application's memory space may be moved among different actual physical locations many times in order to allow different processes to employ shared physical memory devices. That is, the location specified in the application's machine code may actually result in different physical locations at different times because the operating system adds different offsets to the machine-language-specified location.

Despite these expedients, the use of static memory allocation in writing certain long-lived applications makes it difficult to restrict storage requirements to the available memory space. Abiding by space limitations is easier when the platform provides for dynamic memory allocation, i.e., when memory space to be allocated to a given object is determined only at run time.

Dynamic allocation has a number of advantages, among which is that the run-time system is able to adapt allocation to run-time conditions. For example, the programmer can specify that space should be allocated for a given object only in response to a particular run-time condition. The C-language library function malloc( ) is often used for this purpose. Conversely, the programmer can specify conditions under which memory previously allocated to a given object can be reclaimed for reuse. The C-language library function free( ) results in such memory reclamation.

Because dynamic allocation provides for memory reuse, it facilitates generation of large or long-lived applications, which over the course of their lifetimes may employ objects whose total memory requirements would greatly exceed the available memory resources if they were bound to memory locations statically.

Particularly for long-lived applications, though, allocation and reclamation of dynamic memory must be performed carefully. If the application fails to reclaim unused memory—or, worse, loses track of the address of a dynamically allocated segment of memory—its memory requirements will grow over time to exceed the system's available memory. This kind of error is known as a “memory leak.”

Another kind of error occurs when an application reclaims memory for reuse even though it still maintains a reference to that memory. If the reclaimed memory is reallocated for a different purpose, the application may inadvertently manipulate the same memory in multiple inconsistent ways. This kind of error is known as a “dangling reference,” because an application should not retain a reference to a memory location once that location is reclaimed. Explicit dynamic-memory management by using interfaces like malloc( )/free( ) often leads to these problems.

A way of reducing the likelihood of such leaks and related errors is to provide memory-space reclamation in a more-automatic manner. Techniques used by systems that reclaim memory space automatically are commonly referred to as “garbage collection.” Garbage collectors operate by reclaiming space that they no longer consider “reachable.” Statically allocated objects represented by a program's global variables are normally considered reachable throughout a program's life. Such objects are not ordinarily stored in the garbage collector's managed memory space, but they may contain references to dynamically allocated objects that are, and such objects are considered reachable. Clearly, an object referred to in the processor's call stack is reachable, as is an object referred to by register contents. And an object referred to by any reachable object is also reachable.

The use of garbage collectors is advantageous because, whereas a programmer working on a particular sequence of code can perform his task creditably in most respects with only local knowledge of the application at any given time, memory allocation and reclamation require a global knowledge of the program. Specifically, a programmer dealing with a given sequence of code does tend to know whether some portion of memory is still in use for that sequence of code, but it is considerably more difficult for him to know what the rest of the application is doing with that memory.

So the programmer can instead have his source program compiled by a compiler that targets a garbage-collected system, i.e., a system that includes an automatic garbage collector. By tracing references from some conservative notion of a “root set,” e.g., global variables, registers, and the call stack, automatic garbage collectors obtain global knowledge in a methodical way. Since a pre-existing garbage collector takes care of reclaiming garbage, the programmer can then concentrate on writing only the “useful” part of the program, which in garbage-collection contexts is called the mutator. From the collector's point of view, what the mutator does is mutate active data structures' connectivity. By using a garbage collector, the programmer is relieved of the need to worry about the application's global state and can concentrate on local-state issues, which are more manageable. The result is applications that are more robust, having no dangling references and fewer memory leaks.

Garbage-collection mechanisms can be implemented by various parts and levels of a computing system. One approach is simply to provide them as part of a batch compiler's output. Consider FIG. 2's simple batch-compiler operation, for example. A computer system executes in accordance with compiler object code and therefore acts as a compiler 10. The compiler object code is typically stored on a medium such as FIG. 1's system disk 17 or some other machine-readable medium, and it is loaded into RAM 14 to configure the computer system to act as a compiler. In some cases, though, the compiler object code's persistent storage may instead be provided in a server system remote from the machine that performs the compiling. The electrical signals that carry the digital data by which the computer systems exchange that code are examples of the kinds of electromagnetic signals by which the computer instructions can be communicated. Others are radio waves, microwaves, and both visible and invisible light.

The input to the compiler is the application source code, and the end product of the compiler process is application object code. This object code defines an application 21, which typically operates on input such as mouse clicks, etc., to generate a display or some other type of output. This object code implements the relationship that the programmer intends to specify by his application source code. In one approach to garbage collection, the compiler 10, without the programmer's explicit direction, additionally generates code that automatically reclaims unreachable memory space.

Even in this simple case, though, there is a sense in which the application does not itself provide the entire garbage collector. Specifically, the application will typically call upon the underlying operating system's memory-allocation functions. And the operating system may in turn take advantage of various hardware that lends itself particularly to use in garbage collection. So even a very simple system may disperse the garbage-collection mechanism over a number of computer-system layers.

To get some sense of the variety of system components that can be used to implement garbage collection, consider FIG. 3's example of a more complex way in which various levels of source code can result in the machine instructions that a processor executes. In the FIG. 3 arrangement, the human applications programmer produces source code 22 written in a high-level language. A compiler 23 typically converts that code into “class files.” These files include routines written in instructions, called “byte codes” 24, for a “virtual machine” that various processors can be software-configured to emulate. This conversion into byte codes is almost always separated in time from those codes' execution, so FIG. 3 divides the sequence into a “compile-time environment” 25 separate from a “run-time environment” 26, in which execution occurs. One example of a high-level language for which compilers are available to produce such virtual-machine instructions is the Java™ programming language. (Java is a trademark or registered trademark of Sun Microsystems, Inc., in the United States and other countries.)

Most typically, the class files' byte-code routines are executed by a processor under control of a virtual-machine process 27. That process emulates a virtual machine from whose instruction set the byte codes are drawn. As is true of the compiler 23, the virtual-machine process 27 may be specified by code stored on a local disk or some other machine-readable medium from which it is read into FIG. 1's RAM 14 to configure the computer system to implement the garbage collector and otherwise act as a virtual machine. Again, though, that code's persistent storage may instead be provided by a server system remote from the processor that implements the virtual machine, in which case the code would be transmitted electrically or optically to the virtual-machine-implementing processor.

In some implementations, much of the virtual machine's action in executing these byte codes is most like what those skilled in the art refer to as “interpreting,” so FIG. 3 depicts the virtual machine as including an “interpreter” 28 for that purpose. In addition to or instead of running an interpreter, many virtual-machine implementations actually compile the byte codes concurrently with the resultant object code's execution, so FIG. 3 depicts the virtual machine as additionally including a “just-in-time” compiler 29. We will refer to the just-in-time compiler and the interpreter together as “execution engines” since they are the methods by which byte code can be executed.

Now, some of the functionality that source-language constructs specify can be quite complicated, requiring many machine-language instructions for their implementation. One quite-common example is a source-language instruction that calls for 64-bit arithmetic on a 32-bit machine. More germane to the present invention is the operation of dynamically allocating space to a new object; the allocation of such objects must be mediated by the garbage collector.

In such situations, the compiler may produce “inline” code to accomplish these operations. That is, all object-code instructions for carrying out a given source-code-prescribed operation will be repeated each time the source code calls for the operation. But inlining runs the risk that “code bloat” will result if the operation is invoked at many source-code locations.

The natural way of avoiding this result is instead to provide the operation's implementation as a procedure, i.e., a single code sequence that can be called from any location in the program. In the case of compilers, a collection of procedures for implementing many types of source-code-specified operations is called a runtime system for the language.

The execution engines and the runtime system of a virtual machine are designed together, so that the engines “know” what runtime-system procedures are available in the virtual machine (and on the target system if that system provides facilities that are directly usable by an executing virtual-machine program.) So, for example, the just-in-time compiler 29 may generate native code that includes calls to memory-allocation procedures provided by the virtual machine's runtime system. These allocation routines may in turn invoke garbage collection routines of the runtime system when there is not enough memory available to satisfy an allocation. To represent this fact, FIG. 3 includes block 30 to show that the compiler's output makes calls to the runtime system as well as to the operating system 31, which consists of procedures that are similarly system-resident but are not compiler-dependent.

Although the FIG. 3 arrangement is a popular one, it is by no means universal, and many further implementation types can be expected. Proposals have even been made to implement the virtual machine 27's behavior in a hardware processor, in which case the hardware itself would provide some or all of the garbage-collection function.

The arrangement of FIG. 3 differs from FIG. 2 in that the compiler 23 for converting the human programmer's code does not contribute to providing the garbage-collection function; that results largely from the virtual machine 27's operation. Those skilled in that art will recognize that both of these organizations are merely exemplary, and many modem systems employ hybrid mechanisms, which partake of the characteristics of traditional compilers and traditional interpreters both.

In short, garbage collectors can be implemented in a wide range of combinations of hardware and/or software. As is true of most of the garbage-collection techniques described in the literature, the invention to be described below is applicable to most such systems. In particular, the invention to be described below is applicable independently of whether a batch compiler, a just-in-time compiler, an interpreter, or some hybrid is employed to process source code. In the remainder of this application, therefore, we will use the term compiler to refer to any such mechanism, even if it is what would more typically be called an interpreter.

As was mentioned above, garbage collection basically involves identifying objects that are reachable or potentially so and reclaiming the memory space occupied by the remaining, unreachable objects. Much of collector operation therefore involves following reference chains. The collector follows a reference in, say, a stack frame to find an object, marks that object as reachable, follows any references in that (reachable) object to the objects to which they refer, marks them as reachable, etc. This requires that the collector be able to tell which locations contain references and which do not.

For this purpose, the collector typically refers to mapping information supplied the mutator's compiler. For each of one or more of a method's “safe points,” i.e., points in the code at which a collector is allowed to interrupt the mutator to perform garbage collection, the compiler provides a map showing where references are located in the registers and in the stack frame that corresponds to the call of that method that was interrupted at that safe point. The collector can begin with a reference thereby found and follow it to an object. When the object's location is thus known, that of the class field it contains is, too. The collector can follow that field's contents to an object map, which the compiler will have provided for that object's class to indicate where in the object its references are located.

But some garbage-collection operations begin not with the location of a reference or an object but with that of a region in which references or other object fields need to be located. An example arises, for example, in so-called incremental collectors, which perform collection in increments, between which the collector retains connectivity information it has gleaned in previous increments. A mutator targeted to a system that uses an incremental collector will often notify the collector that it has modified references. To update its connectivity information when this happens, the collector needs to determine what objects are referred to by those references. But the mutator will often give the collector only an identifier of a region in which a modified reference is located, not the reference's specific location, so the collector must somehow determine the latter from the former.

This need for object-field-from-region operations arises in other garbage-collection situations, too. For example, consider parallel collection, in which different collector threads (typically running on separate processors) are concurrently performing the task of evacuating potentially reachable objects from a region to be reclaimed. The different threads will usually be assigned respective regions to scan. To scan their regions without scanning the same object, they need to identify the boundaries of objects that straddle the dividing lines between regions.

Another example arises in concurrent collection, in which a collector does most of its work concurrently with mutator operation but still interrupts mutator operation briefly for an operation in which reachable-object marking is completed. In such marking, regions identified as having been modified are scanned, but the scanning can be limited to certain objects within the dirty regions. To identify the references in such objects, the object locations within the dirty regions have to be determined.

So the task of finding object fields within known regions arises frequently. A typical way to make it possible to perform such a task involves dividing the heap into regions with which the collector associates respective sets of locator information. We will refer to these regions as cards. We will refer to the set of locator information as a block-offset table, although the information is not necessarily stored in a format that would ordinarily be considered a table. For the sake of concreteness, let us say that some portion of the heap is divided into 512-byte cards and that the collector maintains the block-offset table as a byte array, each byte being the locator entry for a respective card. When the mutator calls for space to be allocated dynamically to a new object, the locator entry for each card occupied by that object may be revised so that the object's location can be inferred from those entries.

Perhaps the simplest approach that has been employed for this purpose is to have the locator entry indicate whether the associated card and an object start at the same address. When an object is allocated at the beginning of a card, the corresponding entry in the block-offset table is marked to reflect that fact. Later, when the collector needs to scan that card for references, it can infer the first object's location from the corresponding locator entry. From that it can determine where that object's class information is and thereby determine where its member references are. Since the collector will thereby also be able to determine where the object ends, it can further determine where the next object begins. From that information, it can also determine where references are in the next object.

Now, copying collectors typically position objects compactly: each object but the last is followed by an object that starts at the next location permitted by alignment rules. In non-copying collectors, on the other hand, objects may be separated by free blocks. But free blocks are like objects in that they, too, typically include “class” fields, which, in their case, identify them as free blocks. They also contain information indicating how long they are. Block-offset tables can therefore be used to find not only objects but also free blocks, and the discussion below will use the term blocks to refer both to objects and to free blocks.

If the block-offset-table entry for a given card in this scheme does not indicate that a block starts at the beginning of the card, a collector scanning for references has to work backward through the block-offset table until it finds one that does. It then starts at that card and works forward through each block. In the case of a free block, it typically uses length information stored in the block to determine where the free block ends. In the case of an object, it typically uses information obtainable through the object's class field to determine where the object ends. This continues until the collector has reached the block that extends into the card of interest. If the block is an object, the collector will use the class information for that object and possibly subsequent ones to locate the references in the card of interest.

In this approach, the operation of locating references can be quite time-consuming. The collector may need to traverse a considerable number of locator entries before it finds a card at whose starting location an object begins. And it may thereafter need to consult the layout information for a large number of blocks before it reaches the block of interest.

To reduce the cost of locating references, some collectors use a different approach, one that is based on the recognition that a card usually starts in the middle of an object. In one implementation, for example, each entry is two bytes and treated as a signed integer. If the entry's value is negative, it tells how many bytes (or words, double words, etc., depending on object alignment) to the left of the card the object begins. Since some objects are so large that a two-byte entry is not big enough to indicate where the object starts, though, a positive value is interpreted as directing that the collector skip to the left a number of locator entries that is equal to the current entry's value and to look there for the needed information. (The terms left and right will refer to opposite directions in the address space. In most systems, left and right can respectively be taken as the directions of decreasing and increasing address value.)

Clearly, this approach tends to make the operation of finding references much less costly than it can be when locator entries indicate only whether an object starts at the card's starting address. But it can make maintenance more costly. To appreciate this, consider a large free block, one that extends over a great number of cards. When an object is allocated, the free block is broken into two pieces: an initial part, in which the newly allocated object will reside, and the remainder, which remains a free block. Suppose that the newly allocated object extends into some number of the cards whose respective locator entries direct the collector to look some number of locator entries to the left in order to find one from which the block's location can be inferred. Subsequent locator entries, which correspond to cards occupied by the reduced-size free block, will need to be revised, since they would otherwise direct the collector to a locator entry from which the collector would find the new object's location, not the location of the remaining free block. If, as often happens, the remaining free block is very large, the process of updating the block-offset table would be onerous. This problem does not arise with the previous approach, i.e., with the approach in which the block-offset table tells only whether the corresponding card begins in a block. As was explained above, though, the block-finding operation can be expensive in that approach.

### SUMMARY OF THE INVENTION

I have devised an approach that enables an advantageous compromise to be made between the cost of a block-offset table's maintenance and the cost of its use. This approach is like one of the conventional approaches in that a plurality of possible locator values are interpreted as entry offsets: that many values indicate that the collector should consult the locator entry corresponding to the card some number of cards to the left. In accordance with my approach, though, the numbers of cards represented by those values populate a relatively large range only sparsely. Specifically, within the range defined by the highest and lowest numbers of cards that the possible locator values represent, there should be at least N² integers that the possible locator values do not represent, where N is the number of locator values interpreted as entry offsets.

Suppose, for example, that only ten of the possible values that a locator entry can assume are to be interpreted as directing the collector to consult a different locator entry. Rather than having those values represent all numbers of cards between one and ten, this approach may, say, use only values that are powers of four: 1, 4, 16, . . . , 4⁹=262,144. As will be explained in more detail below, the typical result for a block covering a very large number of cards will be a succession of sequences of identical-valued locator entries. So splitting such a large block will necessitate maintenance operations only on the relatively few locator entries near where the locator-entry values change. And, while maintenance cost in this example is relatively low, being linear only in the size of the (typically small) new object and only logarithmic in the size of the (typically large) remainder, the cost of finding the location of a very large block is, in this example, only logarithmic in the block's size.

### BRIEF DESCRIPTION OF THE DRAWINGS

The invention description below refers to the accompanying drawings, of which:

FIG. 1; discussed above, is a block diagram of a computer system in which the present invention's teachings can be practiced;

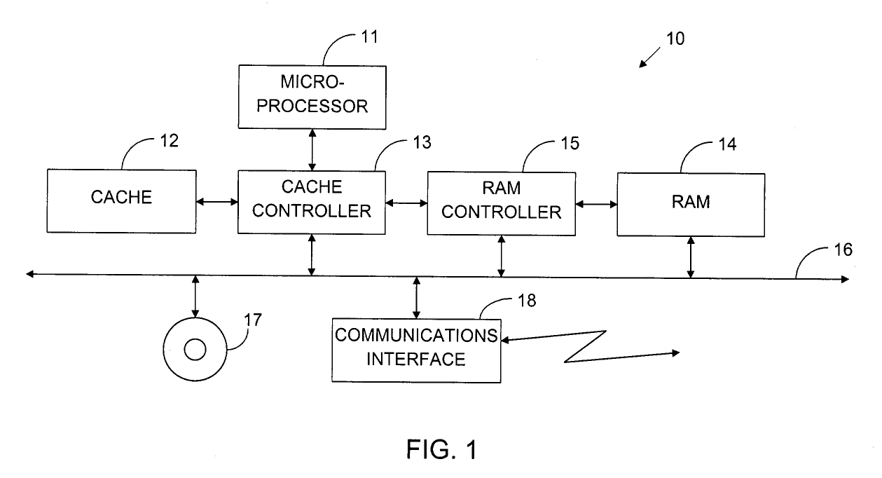

FIG. 2, discussed above, is a block diagram that illustrates a compiler's basic functions;

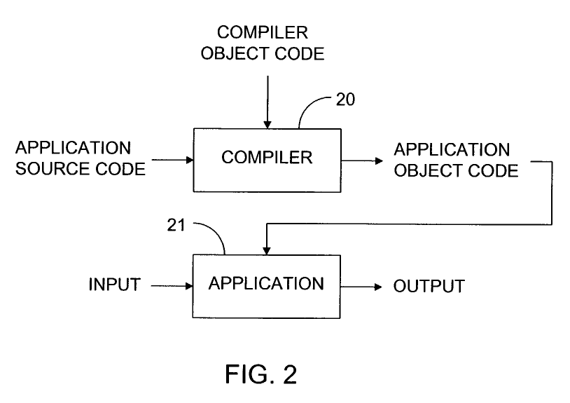

FIG. 3, discussed above, is a block diagram that illustrates a more-complicated compiler/interpreter organization;

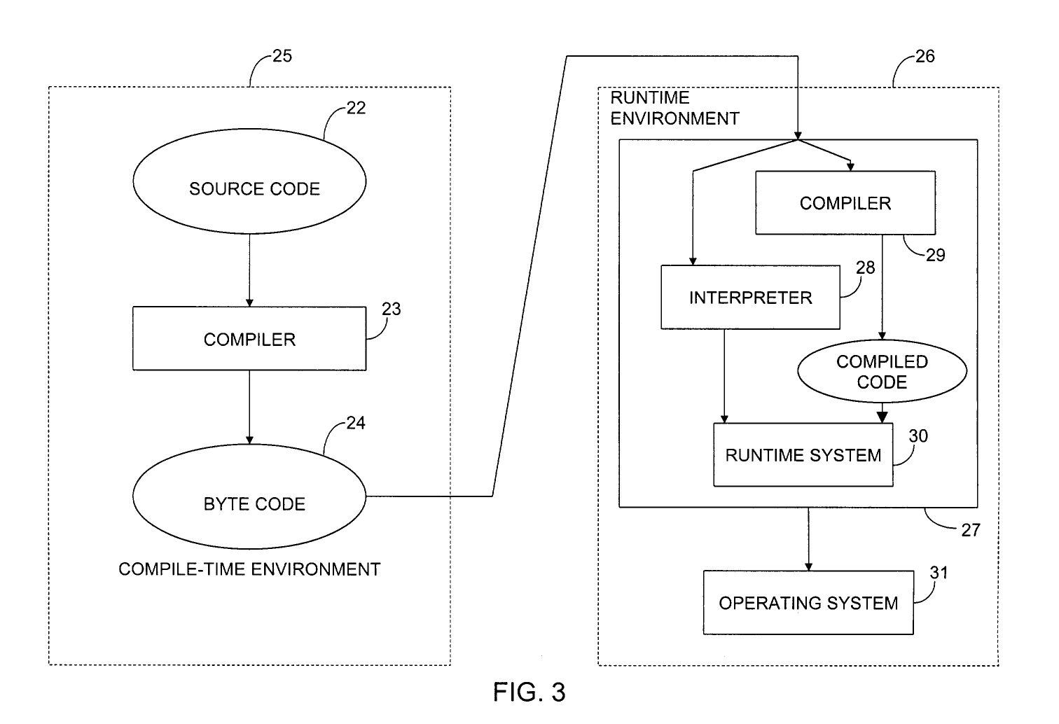

FIG. 4 is a block-offset-table diagram that illustrates by example how one embodiment of the invention performs;

FIG. 5 is a similar diagram depicting the block-offset table after a block has been split; and

FIG. 6 is a listing of a routine for performing some of the block-offset-table up-dating necessitated by the splitting.

### DETAILED DESCRIPTION OF AN ILLUSTRATIVE EMBODIMENT

For the sake of simplicity, let us assume that locator entries for some portion of a heap are stored in a single array, that each entry occupies only a single byte in that array, and that locator entries that are consecutive in the array correspond to contiguous cards. The present invention does not require any of those features, but assuming them simplifies the discussion. In a similar vein, we will assume that each of the cards consists of 512 bytes, that the beginning address of each card ends in nine zeros (log₂512=9), and that all blocks are four-byte aligned, i.e., that each block's starting address ends in two zeros.

In maintaining the block-offset table, the collector will select each entry's value from a set of possible values. Obviously, since the illustrated embodiment uses single-byte entries, the number of possible values can not be more than 256. The set of possible values to which the collector has assigned interpretations and from which it selects to assign values to locator entries may in fact include that many possible values, but it may instead consist of fewer.

In any event, some of those values will direct the collector to refer to a previous locator entry, and other possible values will mean something else. Precisely what those other values' interpretations are is not critical, but we will give an example here for the sake of concreteness. Let us interpret the single-byte contents of a locator entry as an unsigned integer. If all bit sequences are employed, this would yield 256 possible locator entry values, 0-255. In the example, if an entry has a value v in the range 0 to 127, inclusive, it means that the start of the block in which the card associated with the entry begins is v four-byte words to the left of the beginning of that card. Since blocks are four-byte aligned, these 128 values represent (1) the location of a block that begins at the start of the corresponding card and (2) all possible locations at which blocks can begin in the previous card other than that card's starting address. Again, a collector that implements the present invention's teachings does not need to assign these particular interpretations to any of its values. Examples of other value interpretations can be found, for example, in commonly assigned U.S. patent applications Ser. No. ______ of Garthwaite et al. for A Method and Mechanism for Finding References in a Card in Time Linear in the Size of the Card in a Garbage-Collected Heap and No._______ of Garthwaite for Combining Entries in a Card Object Table, both of which were filed on the same date as this application and are hereby incorporated by reference.

But embodiments of the present invention will additionally include values that direct the collector to consult other entries. For the sake of example, let us assume that there are only ten such values, namely, 128-137. In this example, the entry offsets represented by those few values populate a large range sparsely. Specifically, for each value v in this set of ten values, the entry offset is 4^{v-128}. An entry value of 137, for instance, means that, in order to find the location of the object in which the associated card begins, the collector will need to consult the entry for the card 4⁹=262,144 cards to the left of the corresponding card. Clearly, the illustrated embodiment does not include codes for all numbers of cards up to this number. As will become apparent, though, thus populating a range only sparsely can result in low cost both for scanning and for table maintenance.

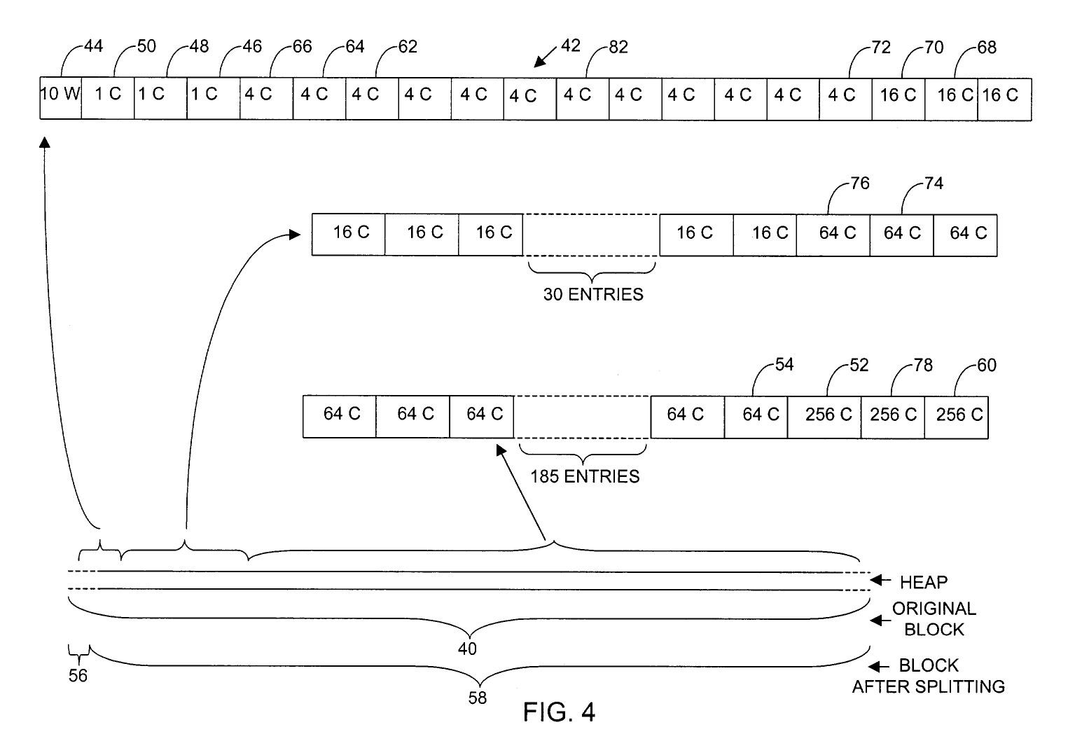

For example, suppose that a block—either an object or a free block—extends through a region of memory represented in FIG. 4 by brace 40. Let us suppose that this block extends over a large number of cards. In particular, let us assume that 259 cards begin within that block and that the block begins ten four-byte words before the start of the first such card. Reference numeral 42 refers to the locator entries for the first nineteen such cards. Entry 44, which is the entry for the card immediately after the one in which the block begins, contains a value representing the fact that the object in which the corresponding card begins starts ten four-byte words ahead of the start of that card. In the encoding described above, the actual value would be 00001010₂, i.e., the bit sequence representing ten. By consulting that value, the collector can locate the block in which the card corresponding to entry 44 begins.

By knowing that block's location, the collector can also determine the meaning of its contents. Suppose, for example, that objects in this system are so laid out that their first fields are class fields. From the information in that field, the collector can determine whether the block represents an object or a free block. If it is a free block, a predetermined location in the free block will typically indicate how long the free block is. If the class field indicates that the block is an object, the collector will be able to use that field's contents to find a map representing the layout of objects belonging to that object's class. This will tell the collector, among other things, where any references contained in that object are located.

Now assume that the collector needs to, say, find the references in the card that corresponds to locator entry 46. Further assume that entry 46's value is 10000000₂, i.e., the bit sequence representing 128. As the drawing suggests, the interpretation given that entry's value is that the collector will need to consult the entry for the card one to the left of the associated card in order to determine the location of the block in which the corresponding card begins. The collector will accordingly consult block 48, but that block, too, will direct it to another entry, namely, entry 50. Entry 50 will direct the collector to entry 44, and the collector will be able to conclude from that entry that the block begins ten four-byte words to the left of the card with which entry 44 is associated.

Although the collector therefore needs to step through several entries before it arrives at the desired information, the number of such steps does not increase rapidly as the block's size grows. To appreciate this, consider a situation in which the collector needs to determine the contents of the card associated with entry 52, i.e., of the card 256 cards to the right of the one with which entry 44 is associated. That entry's value directs the collector to consult card 44, from which the collector can infer the block's location immediately.

Actually, the number of steps would have been greater if the card to be scanned had been the card immediately to that card's left, i.e., the card with which entry 54 is associated. That card is located 255 cards to the right of the one associated with card 44. By directing the collector to consult the entry sixty-four entries to the left of entry 54, it tells the collector to consult the entry for the card 191 cards to the right of the one with which entry 44 is associated. That card in turn directs the collector to consult the entry for the card 127 cards to the right of entry 44's, and that entry in turn directs the collector to the entry for the card 53 cards to the right of entry 44's. The collector would then consult the entries for the cards 37, 21, 5, and then 1 card to the right of entry 44's before finally reaching entry 44, which gives the block's location. So, although the collector needs to read four entries to determine block location for the card four cards into the block, it can find the block location for a card 256 cards into the block by consulting only five more. And the maximum cost similarly increases only logarithmically up through the top size, namely, 262,144, for which the illustrated encoding has an interpretation.

Now, in the illustrated scenario the cost of locating the block in which a card begins is greater for the illustrated embodiment than it would be in a system in which there are possible values whose interpretations respectively represent every number of cards in the range from, say, 1 to 255. But the illustrated embodiment is much less expensive for a much larger block. Moreover, as will presently become apparent, the table in such a system would cost considerably more to maintain.

To appreciate this, consider allocating a new object 56 that starts where block 40 does and ends twenty words before the end of the card with which entry 50 is associated. This splits the original free block so that a free block 58 slightly smaller than block 40 remains. When that happens, entry 44 will still be correct, as will entry 50, since their cards both now start in an object that begins at the address at which the free block started previously.

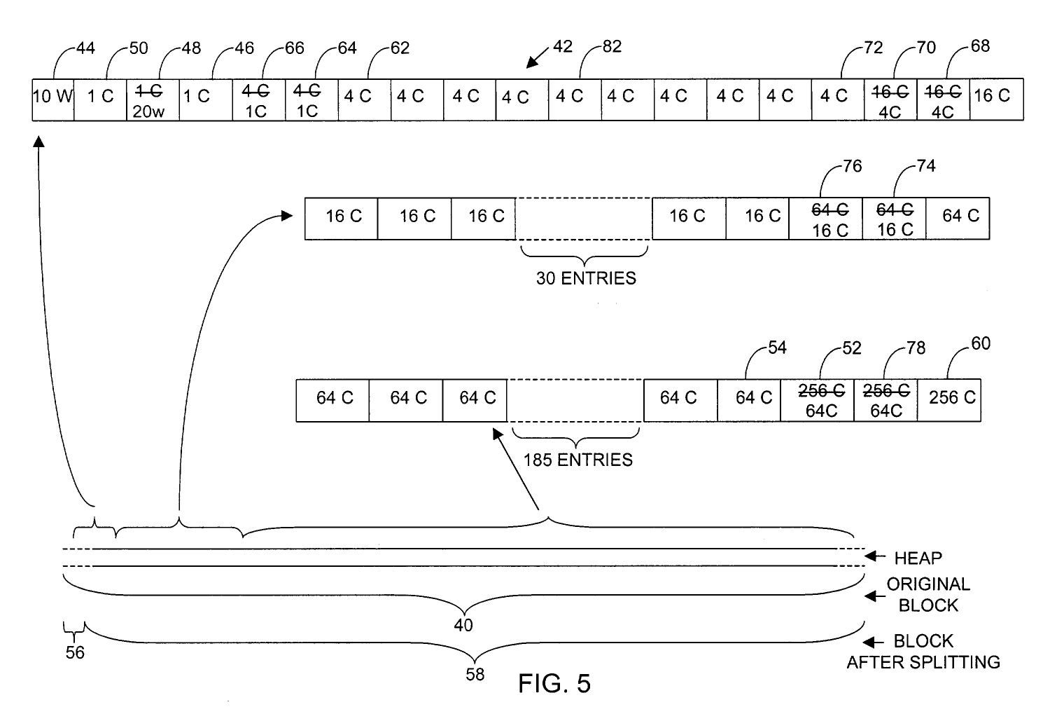

The start of the now-smaller free block 58 in which the card associated with locator entry 48 now begins is located in the immediately previous card, so locator entry 48 should not refer the collector to another entry. Instead, it should specify how many words ahead of the start of its associated card that block begins. So the collector revises entry 48, as FIG. 5 indicates.

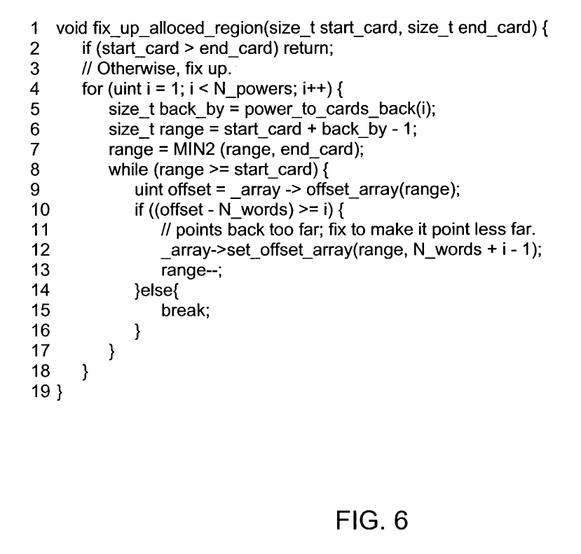

It then proceeds to make whatever further revisions are needed. To this end, it may employ a routine similar to that depicted in FIG. 6. As that drawing's first line indicates, the routine there illustrated takes two arguments, namely, start_card and end_card. Now, as was just explained, the shortened free block begins in the card associated with entry 50, and entry 48 tells where within that card the block begins. All other entries for cards that begin in that block will have values that redirect the collector to another entry, and start card is the index of the card corresponding to the first such entry, namely, entry 46. If entry 60 is the last such card, then end_card is the index of that entry.

Because of the environment in which the illustrated routine is called, the routine may be passed a start_card value that exceeds the end_card value. If this happens, the routine simply returns, as the second line indicates. Otherwise, the routine performs a loop represented by the fourth through eighteenth lines. As was mentioned above, each of the possible entry-offset values, i.e., of the values that redirect the collector to a different entry, is to be interpreted as a number of cards, and each such number is a power of four: it is four raised to some exponent value. The exponent for the first such value is zero: it represents an entry offset of a single card. The loop just mentioned is performed once for each of the other exponents, i.e., for all exponents greater than zero. The loop index i in the fourth line is the exponent currently being considered, and N_powers is the number of such exponents, which we have assumed is ten in the illustrated embodiment (so that nine is the largest exponent, since zero is included in the set of legal exponents).

The power_to_cards_back( ) routine called in the fifth line computes 4¹=4 since i is currently 1. This is the number of cards by which the second of the possible redirecting values redirects the collector. Inspection of FIG. 5 reveals that this is an appropriate value for entry 62: consulting the entry 48 that is four entries to the left does indeed tell where the block begins. But any entry not as far to the right of entry 48 as entry 62 is should not have that value. Therefore, the second-row operation computes the index for the first such entry, namely, entry 64, that should not be interpreted as redirecting the collector back by as many as four entries. It places this value in the range variable.

Now, it sometimes happens that the block being split will be relatively small, and the end_card will not be that far behind the start_card. In that case, range would be adjusted to equal end_card, as the seventh line indicates.

The inner loop, which the eighth through seventeenth lines depict, determines for cards successively farther to the left whether the corresponding locator entry points too far to the left. The ninth line represents calling a routine that returns the value of the locator entry whose index is range. As was stated above, that locator entry is initially entry 64 in the illustrated example. As FIG. 4 indicates, that entry's value is the one that is interpreted to mean that the collector should consult the entry for the card four cards to the left i.e., that value is 128+log₄4=129. This is the offset value that results from the ninth-line operation. The tenth-line operation computes from offset the exponent that it represents and compares it with the exponent i for the current loop iteration. In the case of FIG. 4's entry 64, this exponent value is log₄4=1, so it is not less than the current loop iteration's exponent value i=1, and the conclusion of the tenth-line test is therefore that FIG. 4's entry 64 needs to be changed. The twelfth line calls a routine for doing so, and that routine replaces that entry's value with the one interpreted as directing the collector to consult the entry only one entry to the left, not four. FIG. 5 shows the result.

We digress at this point to note that, although the illustrated routine's purpose is to revise entries in the manner just explained in connection with entry 64, the values before revision could still be used to find block locations. Suppose, for example, that the collector is operating in a multi-threaded system and that a separate collector thread is attempting to locate the block in which the card associated with entry 64 begins. If that thread consults entry 64 after the new object has been written but before entry 64 has been revised, it will be directed to entry 44 and thereby find the location of the newly allocated object, not of the shortened free block. By finding that object and noting its size, though, that thread will conclude that the block it has found does not extend far enough and that the “class” information for the next block needs to be consulted. So entry 44, to which entry 64 directs the collector before getting revised, does contain information from which the collector can find the block containing the beginning of the card associated with entry 64. But revision is valuable because using that information is not as efficient as using the information in entry 48.

The thirteenth-line operation reduces the value of range by one so that the next execution of the inner loop is performed for FIG. 4's entry 66. As FIG. 5 indicates, the result is the same as it was for entry 64: the value is changed so that it directs the collector only one entry to the left, not four.

The next iteration of the inner loop is directed to FIG. 4's entry 46. This time, the exponent computed from the entry in the tenth-line step is zero, not one. Consequently, that entry's value is not changed, and, as the fourteenth- and fifteenth-line instructions indicate, execution leaves that loop.

Having thus identified and corrected those entries whose values had incorrectly indicated that the collector should consult the entry four entries to the left, the routine now increments the exponent value i, as the fourth line indicates, and proceeds to correct the entries that incorrectly direct the collector to consult entries sixteen entries to the left. For that purpose, it performs the ninth-line operation, which computes the index of the entry fifteen (16−1) entries to the right of the entry 48, i.e., that far to the right of the entry that gives the block's location. In the illustrated example, it thereby computes the index of entry 68. In the manner described above, the routine finds that this entry's value directs the collector too far to the left, and it therefore changes that value, as FIG. 5 indicates.

The inner loop is then repeated for entry 70, and that entry, too, must be revised, as FIG. 5 indicates. When the routine reaches entry 72, though, it finds that the entry offset represented by the entry is not too large. The collector does not revise that entry, and, in accordance with the fourteenth- and fifteenth-line instructions, execution again leaves the inner loop. So none of the entries in the sequence beginning at entry 62 and ending at entry 72 needs to be revised. Similar outer-loop iterations find that entries 74, 76, 78, and 52, are the only other entries that need to be revised, as FIG. 5 indicates.

In short, only seven of the 257 cards that begin in the shortened free block need to have their entries revised. And reflection reveals that the number of needed revisions would grow only very slowly with the size of that free block. If that block were 256 times as large, for example, only eight additional revisions would be needed. In the illustrated embodiment, that is, the number of needed revisions grows only logarithmically with the size of the remaining block, and it grows linearly only with the size of the (typically much smaller) block removed from the start of it. So the illustrated embodiment represents a highly advantageous compromise between the cost of finding a block's location and the cost of revising locator entries when large blocks are split.

Much of this advantage results from the fact that the numbers of entry offsets that the entry-offset values represent populate the range from 1 to 262,144 (and, indeed, even the range from 1 to 256) only sparsely: they represent only ten offsets out of 262,144. Of course, not all embodiments of the invention will populate the range that sparsely. To benefit adequately from the present invention's teachings, though, the number of integers in the range that the entry-offsets values represent should be at least the square of the number of such values.

For the sake of simplicity, the foregoing example included only two types of possible code values. The interpretations of one type are that they direct the collector to consult some previous entry. The interpretations of the other type are that they give the position of the including block's first byte relative to the card with which the entry is associated. By following the instructions given by the former, entry-offset type, the collector eventually reaches an entry whose value is of the latter type. It thereby determines the including block's location. Now, any of the invention's embodiments will include some code values that are interpreted as giving a block's location. But not all such codes need to give the block's location in terms of when it begins or how far that is to the left of the associated card. As the above-mentioned Garthwaite et al. application indicates, for example, some locator values may instead be interpreted as indicating that the object begins somewhere in the middle of the associated card. And, although most schemes will give the block's location by specifying its starting address, there is no reason why the location could not instead be given in terms of, say, some other known field in the block.

As the Garthwaite et al. application also indicates, not all code values need be of one or the other of the two types mentioned above. Some, for instance, may not deal with block location at all. They may instead specify the locations of, say, references without indicating the location of the object within which those references occur. Coding schemes that implement the present invention's teachings may additionally include interpretations such as these and/or others.

For example, suppose that, instead of the indicated value, FIG. 4's entry 82 had a value that indicates only where certain references are located within the associated card, i.e., that it did not give any information about block location. If some other entry redirected the collector to that entry, it could be interpreted additionally as directing the collector to, say, the entry immediately to the left.

Also, while all values of the redirecting type in the illustrated embodiment are interpreted as presenting a power of four as the entry-offset value, some base other than four could be employed. I have used powers of sixteen, for example. For computational reasons, of course, it is preferable for the base to be a power of two. But computational simplicity is not restricted to strict exponential progressions. Another computationally simple sequence is {1, 2, 8, 32, 128 . . . }. This sequence is, like the previous one, of the general type in which the first value is unity and all subsequent values form a subsequence in which the subsequence's ith value is abⁱ; in this case, a=½ and b=4.

But the gaps in the possible entry-offset amounts would not have to be produced by such progressions. Examples of other possibilities are the Fibonacci numbers (1, 2, 3, 5, 8, 13, . . . ), the factorials (1, 2, 6, 24, . . . ), the number of combinations of 2n things taken n at a time (1, 2, 6, 20, 105, . . . ), some power of the positive integers, such as {1, 8, 27, 64, 125 . . . ), etc. All that is needed is that there be some gaps in the progression of values. It is highly preferable, though, that those gaps tend to grow with increasing value.

Also, although there were gaps between each pair of successive possible offset values in the illustrated embodiment, many embodiments will not be so arranged. To fill or reduce the gaps at the lower end of the range, for example, some embodiments may add values to, say, the abⁱ progression mentioned above. Still, if that progression's benefits are to be pronounced enough, it is preferable for the highest abⁱ value to exceed the square of the number of values interpreted as entry offsets.

So the present invention can be employed in a wide range of embodiments and constitutes a significant advance in the art.

What is claimed is:

1. For operating a computer system including memory to find locations of blocks in the memory, a method comprising:
A) treating at least a portion of a heap in the memory as divided into cards;
B) associating respective locator entries with the cards;
C) maintaining the locator entries by assigning thereto respective values selected from a set of possible locator values with which respective locator-value interpretations are associated, the locator-value interpretation only of each locator value vᵢ in an entry-offset subset {v₁, v₂, . . . , v_{N}} of the possible locator values being that the location of a block containing the start of the card associated with a given locator entry having that locator value vᵢ can be determined from the locator entry associated with the card located a number D(vᵢ) cards to the left of the card associated with the given entry, the locator-value interpretations of the values v₁ through v_{N} in the entry-offset subset being such that D(v₁)≦D(v₂)≦. . . ≦D(v_{N}) and that there are at least N² integers d greater than D(v₁) but less than D(v_{N}) for which there is no locator value vᵢ in the entry-offset subset such that D(vᵢ)=d; and
D) using the locator entries to find block locations in accordance with those interpretations:

2. A method as defined in claim 1 wherein D(v₁)<D(v₂) <. . . <D(v_{N}).

3. A method as defined in claim 2 wherein the set of possible locator values additionally includes a block-offset subset for which the locator-value interpretation of each value uᵢ is that a block is located at an offset O(uᵢ) from the card associated with which a locator entry whose value is uᵢ.

4. A method as defined in claim 1 wherein the entry-offset subset {v₁, v₂, . . . , v_{N}} includes locator values {w₁, w₂, . . . , w_{M}} such that D(wᵢ)=abⁱ, where ab^{M}≧N².

5. A method as defined in claim 4 wherein the set of possible locator values additionally includes a block-offset subset for which the locator-value interpretation of each value uᵢ is that a block is located at an offset D(uᵢ) from the card associated with which a locator entry whose value is uᵢ.

6. A method as defined in claim 4 wherein a=1.

7. A method as defined in claim 4 wherein b is a power of two.

8. A method as defined in claim 4 wherein D(v₁)=1 and M=N−1.

9. A method as defined in claim 8 wherein the set of possible locator values additionally includes a block-offset subset for which the locator-value interpretation of each value uᵢ is that a block is located at an offset D(uᵢ) from the card associated with which a locator entry whose value is uᵢ.

10. A method as defined in claim 8 wherein a=1.

11. A method as defined in claim 8 wherein b is a power of two.

12. A method as defined in claim 11 wherein a=1.

13. A method as defined in claim 12 wherein b=16.

14. A method as defined in claim 1 wherein the set of possible locator values additionally includes a block-offset subset for which the locator-value interpretation of each value uᵢ is that a block is located at an offset D(uᵢ) from the card associated with which a locator entry whose value is uᵢ.

15. A computer system that includes memory and comprises:
A) processor circuitry operable to execute processor instructions;
B) memory circuitry, to which the processor circuitry is responsive, that contains processor instructions readable by the processor circuitry to configure the computer system as a garbage collector that:
i) treats at least a portion of a heap in the memory as divided into cards;
ii) associates respective locator entries with the cards;
iii) maintains the locator entries by assigning thereto respective values selected from a set of possible locator values with which respective locator-value interpretations are associated, the locator-value interpretation only of each locator value vᵢ in an entry-offset subset {v₁, v₂, . . . , v_{N}} of the possible locator values being that the location of a block containing the start of the card associated with a given locator entry having that locator value vᵢ can be determined from the locator entry associated with the card located a number D(vᵢ) cards to the left of the card associated with the given entry, the locator-value interpretations of the values v₁ through v_{N} in the entry-offset subset being such that D(v₁)≦D(v₂)≦. . . ≦D(v_{N}) and that there are at least N² integers d greater than D(vᵢ) but less than D(v_{N}) for which there is no locator value vᵢ in the entry-offset subset such that D(vᵢ)=d; and
C) uses the locator entries to find block locations in accordance with those interpretations.

16. A computer system as defined in claim 15 wherein D(v₁)<D(v₂)<. . . <D(v_{N}).

17. A computer system as defined in claim 16 wherein the set of possible locator values additionally includes a block-offset subset for which the locator-value interpretation of each value uᵢ is that a block is located at an offset O(uᵢ) from the card associated with which a locator entry whose value is uᵢ.

18. A computer system as defined in claim 15 wherein the entry-offset subset {v₁, v₂, . . . , v_{N}} includes locator values {w₁, w₂, . . . , w_{M}} such that D(wᵢ)=abⁱ, where ab^{M}≧N².

19. A computer system as defined in claim 18 wherein the set of possible locator values additionally includes a block-offset subset for which the locator-value interpretation of each value uᵢ is that a block is located at an offset D(uᵢ) from the card associated with which a locator entry whose value is uᵢ.

20. A computer system as computer system in claim 18 wherein a=1.

21. A computer system as defined in claim 18 wherein b is a power of two.

22. A computer system as defined in claim 18 wherein D(v₁)=1 and M=N−1.

23. A computer system as defined in claim 22 wherein the set of possible locator values additionally includes a block-offset subset for which the locator-value interpretation of each value uᵢ is that a block is located at an offset D(uᵢ) from the card associated with which a locator entry whose value is uᵢ.

24. A computer system as defined in claim 22 wherein a=1.

25. A computer system as defined in claim 22 wherein b is a power of two.

26. A computer system as defined in claim 25 wherein a=1.

27. A computer system as defined in claim 26 wherein b=16.

28. A computer system as defined in claim 15 wherein the set of possible locator values additionally includes a block-offset subset for which the locator-value interpretation of each value uᵢ is that a block is located at an offset D(uᵢ) from the card associated with which a locator entry whose value is uᵢ.

29. A storage medium containing instructions readable by a computer that includes memory to configure the computer to operate as a garbage collector that:
A) treats at least a portion of a heap in the memory as divided into cards;
B) associates respective locator entries with the cards;
C) maintains the locator entries by assigning thereto respective values selected from a set of possible locator values with which respective locator-value interpretations are associated, the locator-value interpretation only of each locator value vᵢ in an entry-offset subset {v₁, v₂, . . . , v_{N}} of the possible locator values being that the location of a block containing the start of the card associated with a given locator entry having that locator value vᵢ can be determined from the locator entry associated with the card located a number D(vᵢ) cards to the left of the card associated with the given entry, the locator-value interpretations of the values v₁ through v_{N} in the entry-offset subset being such that D(v₁)≦D(v₂)≦. . . ≦D(v_{N}) and that there are at least N² integers d greater than D(v₁) but less than D(v_{N}) for which there is no locator value vᵢ in the entry-offset subset such that D(vᵢ)=d; and
D) uses the locator entries to find block locations in accordance with those interpretation.

30. A storage medium as defined in claim 29 wherein D(v₁)<D(v₂)<. . . <D(v_{N}).

31. A storage medium as defined in claim 30 wherein the set of possible locator values additionally includes a block-offset subset for which the locator-value interpretation of each value uᵢ is that a block is located at an offset O(uᵢ) from the card associated with which a locator entry whose value is uᵢ.

32. A storage medium as defined in claim 29 wherein the entry-offset subset {v₁, v₂, . . . , v_{N}} includes locator values {w₁, w₂, . . . , w_{M}} such that D(wᵢ)=abⁱ, where ab^{M}≧N².

33. A storage medium as defined in claim 32 wherein the set of possible locator values additionally includes a block-offset subset for which the locator-value interpretation of each value uᵢ is that a block is located at an offset D(uᵢ) from the card associated with which a locator entry whose value is uᵢ.

34. A storage medium as defined in claim 32 wherein a=1.

35. A storage medium as defined in claim 32 wherein b is a power of two.

36. A storage medium as defined in claim 32 wherein D(v₁ )=1 and M=N−1.

37. A storage medium as defined in claim 36 wherein the set of possible locator values additionally includes a block-offset subset for which the locator-value interpretation of each value uᵢ is that a block is located at an offset D(uᵢ) from the card associated with which a locator entry whose value is uᵢ.

38. A storage medium as defined in claim 36 wherein a=1.

39. A storage medium as defined in claim 36 wherein b is a power of two.

40. A storage medium as defined in claim 36 wherein a=1.

41. A storage medium as defined in claim 40 wherein b=16.

42. A storage medium as defined in claim 29 wherein the set of possible locator values additionally includes a block-offset subset for which the locator-value interpretation of each value uᵢ is that a block is located at an offset D(uᵢ) from the card associated with which a locator entry whose value is uᵢ.

43. An electromagnetic signal representing sequences of instructions that, when executed by a computer system that includes memory:
A) treats at least a portion of a heap in the memory as divided into cards;
B) associates respective locator entries with the cards;
C) maintains the locator entries by assigning thereto respective values selected from a set of possible locator values with which respective locator-value interpretations are associated, the locator-value interpretation only of each locator value vᵢ in an entry-offset subset {v₁, v₂, . . . , v_{N}} of the possible locator values being that the location of a block containing the start of the card associated with a given locator entry having that locator value vᵢ can be determined from the locator entry associated with the card located a number D(vᵢ) cards to the left of the card associated with the given entry, the locator-value interpretations of the values v₁ through v_{N} in the entry-offset subset being such that D(v₁)≦D(v₂)≦. . . ≦D(v_{N}) and that there are at least N² integers d greater than D(v₁) but less than D(v_{N}) for which there is no locator value vi in the entry-offset subset such that D(vᵢ)=d; and
D) uses the locator entries to find block locations in accordance with those interpretations.

44. A electromagnetic signal as defined in claim 43 wherein D(vᵢ)<D(v₂)<. . . <D(v_{N}).

45. A electromagnetic signal as defined in claim 44 wherein the set of possible locator values additionally includes a block-offset subset for which the locator-value interpretation of each value uᵢ is that a block is located at an offset O(uᵢ) from the card associated with which a locator entry whose value is uᵢ.

46. A electromagnetic signal as defined in claim 43 wherein the entry-offset subset {v₁, v₂, . . . , v_{N}} includes locator values {w₁, w₂, . . . , w_{M}} such that D(wᵢ)=abⁱ, where ab^{M}≧N².

47. A electromagnetic signal as defined in claim 46 wherein the set of possible locator values additionally includes a block-offset subset for which the locator-value interpretation of each value uᵢ is that a block is located at an offset D(uᵢ) from the card associated with which a locator entry whose value is uᵢ.

48. A electromagnetic signal as defined in claim 46 wherein a=1.

49. A electromagnetic signal as defined in claim 46 wherein b is a power of two.

50. A electromagnetic signal as defined in claim 46 wherein D(v₁) =1 and M=N−1.

51. A electromagnetic signal as defined in claim 50 wherein the set of possible locator values additionally includes a block-offset subset for which the locator-value interpretation of each value uᵢ is that a block is located at an offset D(uᵢ) from the card associated with which a locator entry whose value is uᵢ.

52. A electromagnetic signal as defined in claim 50 wherein a=1.

53. A electromagnetic signal as defined in claim 50 wherein b is a power of two.

54. A electromagnetic signal as defined in claim 53 wherein a=1.

55. A electromagnetic signal as defined in claim 54 wherein b=16.

56. A electromagnetic signal as defined in claim 43 wherein the set of possible locator values additionally includes a block-offset subset for which the locator-value interpretation of each value uᵢ is that a block is located at an offset D(uᵢ) from the card associated with which a locator entry whose value is uᵢ.

57. A garbage collector comprising:
A) means for treating at least a portion of a heap in a computer system's memory as divided into cards;
B) means for associating respective locator entries with the cards;
C) means for maintaining the locator entries by assigning thereto respective values selected from a set of possible locator values with which respective locator-value interpretations are associated, the locator-value interpretation only of each locator value vᵢ in an entry-offset subset {v₁, v₂, . . . , v_{N}} of the possible locator values being that the location of a block containing the start of the card associated with a given locator entry having that locator value vᵢ can be determined from the locator entry associated with the card located a number D(vᵢ) cards to the left of the card associated with the given entry, the locator-value interpretations of the values v₁ through v_{N} in the entry-offset subset being such that D(v₁)≦D(v₂)≦. . . ≦D(v_{N}) and that there are at least N² integers d greater than D(v₁) but less than D(v_{N}) for which there is no locator value vᵢ in the entry-offset subset such that D(vᵢ)=d; and
D) means for using the locator entries to find block locations in accordance with those interpretations.
